(19) United States
(12) Patent Application Publication
(10) Pub. No.: US 2009/0301347 A1
(43) Pub. Date: Dec. 10, 2009

(54) COMPOSITION BASED ON PRODUCTS STEMMING FROM INDUSTRIAL RESIDUES IN THE PROCESSING OF FRUITS, ESPECIALLY APPLES, USE THEREOF, METHOD FOR PROCESSING THEM AND PRODUCTS THUS OBTAINED

(76) Inventor: Alberto Volcan, Bolzano (IT)

Correspondence Address: JACOBSON HOLMAN PLLC, 400 SEVENTH STREET N.W., SUITE 600, WASHINGTON, DC, 20004, US

(21) Appl. No.: 12/309,681

(22) PCT Filed: Jul. 26, 2007
(86) PCT No.: PCT/IB2007/002138

§ 371 Date: Jun. 25, 2009

(30) Foreign Application Priority Data
Jul. 28, 2006 (IT) BZ2006A000034
Aug. 16, 2006 (IT) BZ2006A000038

(51) Int. Cl. C09D 103/02; C09D 101/00; B27N 3/02

(52) U.S. Cl. 106/203.2; 106/206.1; 264/109

(57) ABSTRACT

What is described is a composition based on products stemming from industrial residues in the processing of fruits, especially of apples. The composition of vegetable products comprises dried apple meal stemming from industrial residues in the processing of fruits, especially of apples.

The present invention relates to a composition based on vegetal products coming from industrial residuals of fruit processing, particularly apples, the use of said composition, the processing procedure and the products thus obtained, according to the identifying section of claim 1.

Compositions of this type based on vegetal polysaccharides used as binders are known for example from the Romanian patent application RO 118022. Compositions of this type are envisaged for being used in the food and pharmaceutical industry, for manufacturing leather products, for binding books, etc. . . . . However, a composition of this type contains components that are expensive in terms of preparation and that must be accurately checked in order to respect the proprieties of the binder itself.

Various methods are known for obtaining sheet products similar in appearance to natural leather using various materials and blends of the latter, of different structures.

The imitation leather obtained is hence a composition of various substances often also with a support structure that makes the product itself stable.

The methods of the known type are hence very complicated, they require composite materials and are very expensive.

The object of the present invention is therefore to avoid an expensive production based also on components especially prepared to obtain a vegetal paste that does not represent any risk for the environment.

The object is achieved thanks to a composition based on vegetal products coming from industrial residuals of fruit processing, particularly apples, and thanks to its use as a paste presenting the characteristics of the identifying section of claim 1.

A further object of the present invention is to simplify a method for obtaining imitation leather and for proposing an imitation leather of simple composition.

This further object is achieved according a method for producing imitation leather as in the identifying section of the main claims on the method and the imitation leather.

The imitation leather thus obtained, despite being a perfectly machinable product, is subject to possible enhancements in terms of softness and colouring.

Therefore, acid and chemical dyes have been tested, leading to completely negative results.

A further object of the present invention is therefore to make a more machinable vegetal imitation leather and to propose a more appropriate dye to vegetal imitation leather.

This object is achieved by means of a procedure for producing vegetal imitation leather, with synthesis of various colours of vegetal-food origin as in the identifying section of claim 1.

The invention represents a new era in the field of things and adhesives. In fact, the new adhesive developed is produced with vegetal products, dried apple flour, coming from industrial residuals of apple processing and 95%-biodegradable paste.

The mixture obtained consists of a minimum part of natural paste (5-10-15%) and the remaining part exclusively of apple flour, bran flour, flour of nutshell residuals, potato peel flours and of all the vegetal residuals coming from industrial and agricultural processing. The percentage of paste depends on the use of the additive produced and used in various sectors:
industry;
craft;
building;
mechanics, etc. . . . .

The blend of these two components: 0-1000 micron ground apple flour, containing 72% of natural fibres, fructose and pectin, along with a vegetal binder consisting of various starches and vegetal molecules, create a new product unique in its kind.

High tensile strength between wood-wood, iron-iron and other industrial products.

The tests carried out and certified by IMAL National on the binders are as follows:
wood-wood tensile strength 6.5 N/mm2
iron-iron tensile strength 4.7 N/mm2

The average tensile strength between the various industrial components is 4N/mm2.

Tests carried out after modifying the granulometry of the apple product have proven that the adhesive varies and modifies its tensile strength. The adhesive produced, which is unique in its kind, is: odourless; easily machinable, cold and heat resistant and it stiffens in contact with air.

The residual can be cleaned with both hot and cold water.

With respect to the toxic and vinyl conventional adhesives currently on the international market, the new product presents the following advantages:
it is not inflammable;
it is not toxic;
it does not irritate eyes and skin;
it does not cause dizziness and drowsiness;
it does not damage the environment.

Research performed by TIS in Bolzano have proven that the wet-based product having an energy value of 0.6 [kWh/kg] when dried has an energy value of 2.7 [kWh/kg].

The multiple possible variables of this vegetal adhesive have, however, a unique irreplaceable base of 100 vegetal residuals.

Examples of application of the tensile strength
1) Gluing on Iron
1. sample 4.2 N/m2
2. sample 4.4 N/m2
3. sample 4.6 N/m2

2) Gluing on Wood
1. sample 4.9 N/m2
2. sample 4.9 N/m2
3. sample 4.8 N/m2

Using a substance made of dried fruit as a base material, it can be ground to a size suitable for being subjected to pressing between two surfaces adapted to obtaining a laminate material which can be used as imitation leather.

In order to perform the various phases of grinding, collection and distribution of the ground material, devices and systems known in the art can be used, such as for example belts conveying the ground and blended material at a pressure of 50 to 100 bar.

As base material for imitation leather, as previously said, vegetal materials are preferably used. A binder can be added to these depending on the desired proprieties of the imitation leather, such as for example its flexibility and feel.

In a preferred embodiment glucose, which is present in the substance of apples and other vegetals, is used.

The procedure according to the invention is essentially articulated in the following phases:

reducing several components of vegetal origin.

blending the components as a unit.

adding the blended components to apple flour originating from fruit processing waste, particularly fruit juice, and ground through a mill from 0 to 1000 micron.

Composition of the blend: apple flour, apple-based vegetal adhesive, food colouring, such as red-green-white-blue-yellow or composed colour syntheses.

mixing by means of a mixer, for example an electric one ranging from 40 to 100 rpm, required for the composition of all the vegetal components.

amalgamating at a room temperature of 40° C.

preparing to press the product made into a cylindrical shape, composition of 99.9% of apple flour mixture and 1/1000 of vegetal colour.

Pressing from 80 to 150 atm.

Thickness from 0.5 mm to 10 mm.

After various experiments performed with the synthesis of these vegetal components, the product structure has been modified improving the coloured leather product and making it softer and more elastic.

The colouring is performed dry without any liquids.

As is clear from the above, it is possible to deduce that the various tests performed cannot explain some of the experimental data and that they are not sufficient to accurately interpret all the improvements made to the product, such as for example the specific weight reduced by 75%.

Further characteristics and embodiments will be clear from the claims and the following description of a possible use with reference to the accompanying drawing, in which

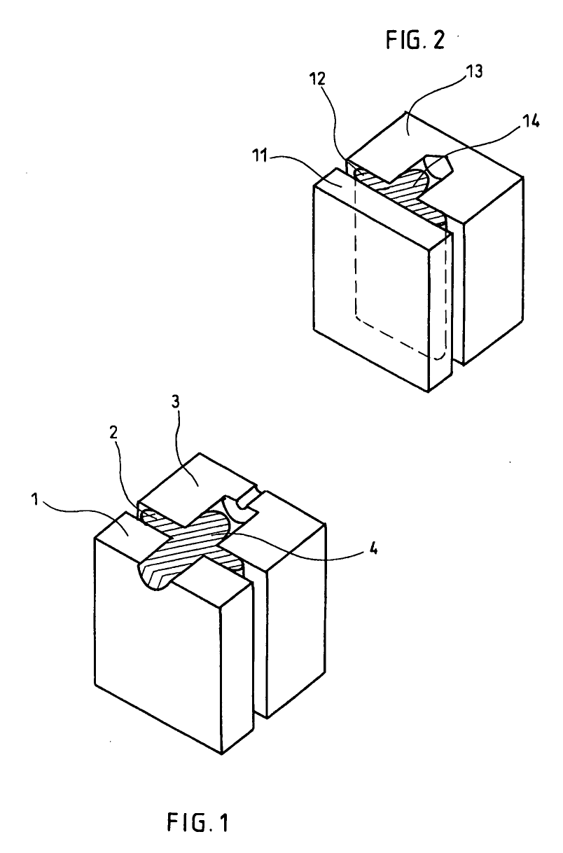

FIG. 1 shows a schematic perspective view of a first variant of connection between two pieces to be glued in a first embodiment, and

FIG. 2 is a perspective view of a second embodiment.

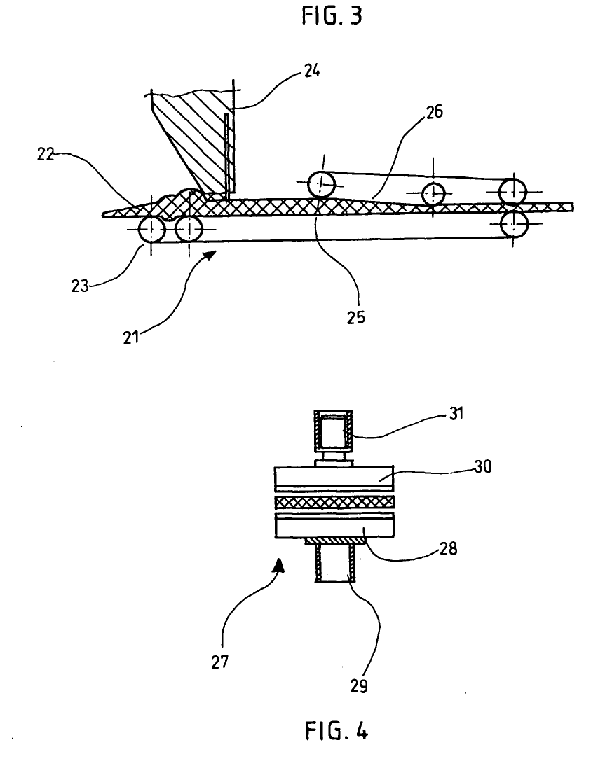

FIG. 3 schematically shows an elevation view of a lamination device, and

FIG. 4 schematically shows an elevation view of a press.

As shown in FIG. 1, on the surfaces of part 1 to be connected to part 3, recesses are obtained opposing each other in such a way that the vegetal paste of the type described, besides connecting the two surfaces opposing each other, can enter both recesses in order to form the respective vegetal nails 4.

In FIG. 2, in only one of the two parts to be connected 11 and 13, a recess is obtained in order to let the paste enter so as to form a nail 14.

The parts to be glued can be of any material, such as for example wood, iron, etc.

As shown in FIGS. 3 and 4, reference number 21 indicates a lamination device as a whole to which minced apples 22 are supplied by means of a lamination belt 23. Further material can be appropriately supplied from a funnel tank. At the output of the lamination belt, the lamination device presents a support a belt 25 transporting the material under a funnel-type compression belt 26 so as to make the compressed material sufficiently stable to be used as imitation leather.

In an embodiment a press 27 (FIG. 2) comprising a support plate 28 can be used, said press being supported by a support 29 and a pressure plate 30 and being operated by a piston 31 in order to press the material 22 onto the support plate 28.

It is understood that any device of the prior art can be used in order to laminate the apple-based material.

C=M*Fμm²=Vegetal leather

C=M/Fμkg=Vegetal paste

1. A composition based on vegetal products, coming from industrial residuals of fruit processing, particularly apples, comprising vegetal products, dried apple flour, coming from industrial residuals of fruit processing, particularly apples, characterised in that it forms imitation leather.

2. The composition according to claim 1, characterised in that the imitation leather contains 95%-biodegradable paste.

3. The composition according to claim 2, characterised in that the imitation leather consists of a mixture with a minimum part of natural paste (5%-10%-15%) and the remaining part of apple flour only.

4. The composition according to claim 2, characterised in that it combines two components: 100 micron ground apple flour, containing 72% of natural fibres, fructose and pectin, along with a vegetal binder that consists of various starches and vegetal molecules.

5. The procedure for the production of imitation leather, starting from a composition according to claim 1, comprising the fruit material mincing phase, particularly apples, characterised in that the material is supplied by compression means adapted to shape a laminate material.

6. The procedure according to claim 5, characterised in that the compression means is formed by belts with branches facing with each other at a distance suitable for forming a laminate material of a determined thickness.

7. The procedure according to claim 5, characterised in that the compression means is formed by a press.

8. The procedure according to claim 5, characterised in that the laminate is coupled with another type of material.

9. The procedure according to claim 5, characterised in that the fruit laminate is coupled with another material as a coating.

10. The imitation leather obtained according to claim 1, characterised in that it consists of 100% of fruit material, particularly apples.

11. The imitation leather obtained according to claim 1, characterised in that it consists up to 1% of a binder.

12. The imitation leather obtained according to claim 1, characterised in that the binder is the glucose contained in fruit.

13. The imitation leather according to claim 1, characterised in that it is coupled with another material.

14. The procedure for the production of vegetal imitation leather, starting from a composition according to claim 1, with synthesis of various colours of vegetal-food origin, characterised by the following stages:
reducing several components of vegetal origin.
blending the components as a unit.
adding the blended components to apple flour originating from fruit processing waste, particularly fruit juice, and ground through a mill from 20 to 100 micron.
composition of the blend: apple flour, apple-based vegetal adhesive, food colouring, such as red-green-white-blue-yellow or composed colour synthesis
mixing by means of a mixer, for example an electric one ranging from 40 to 100 rpm, required for the composition of all the vegetal components
amalgamating at a room temperature of up to 40° C.
preparing to press the product set in a cylindrical shape, composition of 99.9% of apple flour mixture and 1/1000 of vegetal colour.

15. The procedure according to claim 14, characterised in that the pressing takes place between 80 and 150 bar.

16. The procedure according to claim 14, characterised in that the pressing reduces the material to a thickness ranging from 0.5 mm to 10 mm.
